(19) United States
(12) Patent Application Publication
(10) Pub. No.: US 2005/0018086 A1
(43) Pub. Date: Jan. 27, 2005

(54) Image signal detecting apparatus and method thereof capable of removing comb by bad-edit

(75) Inventors: Young-ho Lee, Seoul (KR); Seung-joon Yang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/871,373

(22) Filed: Jun. 21, 2004

(30) Foreign Application Priority Data
Jul. 21, 2003 (KR) 2003-49909

(51) Int. Cl. H04N 9/64

(52) U.S. Cl. 348/700; 348/701

(57) ABSTRACT

An image signal detecting apparatus and a method thereof capable of detecting a 2:2 pull-down image as well as a 3:2 pull-down image with respect to an input image signal. The image signal detecting apparatus includes a SAD calculation unit for calculating summed absolute differences (SADs) among a current field (n), a previous field (n−1), and a next field (n+1) with respect to consecutively input image signals, a pull-down image detection unit, a still image determining unit , a bad-edit detection unit for detecting a bad-edit in the detected pull-down image, and a decision unit for deciding whether the input image signal is the pull-down image or not based on the result of detecting the pull-down image, the result of determining whether the input image signal is a still image by the still image judgment unit, and the result of detecting the occurrence of the bad-edit.

### CROSS-REFERENCE TO RELATED APPLICATION

This application claims the benefit of Korean Patent Application No. 2003-49909, dated Jul. 21, 2003, in the Korean Intellectual Property Office, the disclosure of which is incorporated herein by reference.

### BACKGROUND OF THE INVENTION

1. Field of the Invention

The present invention relates to an image signal detecting apparatus and a method thereof, and more particularly, to an image signal detecting apparatus and a method thereof which detect whether an input image signal is a 3:2 pull-down image or a 2:2 pull-down image.

2. Description of the Related Art

Humans perceive a continuous image if more than 16 sheets of pictures appear in a second. That is, in an image in motion, 16 sheets of pictures per second is the minimum sampling frequency (i.e., Nyquist frequency) for sampling a signal with information preserved. In consideration of this, an image for a movie is processed at a speed of 24 sheets of pictures per second, and an image for a television (TV) is processed at a speed of 25 to 30 sheets of pictures per second.

The movie uses a progressive system that instantaneously stores every picture in a film and progressively projects the pictures on a screen. In the TV, since an image is basically transmitted over the air, each picture is filmed and transmitted through scanning of several hundreds of scanning lines, and then displayed on a screen of a Braun tube by scanning. In the NTSC (National Television System Committee) color TV system adopted in countries like the United States, Japan, and Korea, 30 sheets of pictures, each of which is composed of 525 scanning lines, per second are transmitted, and in the PAL (Phase Alternation by Line) system or SECAM (Sequential Couleur a Memoire) system, 25 sheets of pictures, each of which is composed of 625 scanning lines, per second are transmitted.

Also, the TV uses an interlaced scanning method which divides one picture (i.e., frame) into two fields and alternately scans the two fields in order to effectively present a moving image using limited scanning lines. At this time, the divided fields are called top and bottom fields, odd and even fields, upper and lower fields, etc. Accordingly, the NTSC system processes 60 fields of image per second, and the PAL or SECAM system processes 50 fields of image per second.

When a movie is televised through a TV, every sheet of movie film is transmitted through a converter called a telecine (which is a compound word of a television and a cinema). At this time, if the films are reproduced at TV picture reproducing speed without matching the number of film pictures per second to the number of television pictures per second, since the NTSC system provides 30 sheets of pictures per second, a viewer watches an image in a fast motion. Accordingly, in order to transmit the movie films to the television of the NTSC system, 24 sheets of film pictures per second have to be translated into 60 television fields. This translation is achieved by obtaining 5 fields from 2 sheets of film pictures. A simple and practically used method is to scan 3 fields for the first film picture and to scan 2 fields for the other, which is called “3:2 pull-down method”. In the case of transmitting the movie through the PAL or SECAM TV system, 50 fields should be obtained from 25 pictures (i.e., frames), that is, two fields should be obtained with respect to one frame. This method of scanning two fields with respect to the respective frame is called a “2:2 pull-down” system.

Basically, it is possible to reproduce an original image of 24 frames such as an original movie through a DVD (Digital Video Disk) without having to take intermediate processing. However, since the majority of currently available display devices such as a television use an interlaced scanning method, the DVD is actually manufactured to match the interlaced scanning method. Accordingly, in order to retrieve the title created in the interlaced scanning method to the progressive system, the 3:2 pull-down method should be performed in a reverse manner. It is most important in such a de-interlacing work to accurately recognize the 3:2 pull-down sequence (such a 3:2 pull-down state is usually called “film mode” because it is mainly applied in a movie).

FIG. I is a view showing the 3:2 pull-down processing. Referring to FIG. 1, two frames are scanned into 5 fields. One film frame is composed of a top field of odd-number lines and a bottom field of even-number lines. To obtain 3 fields from one frame for a television, any one of the top field and the bottom field has to be repeatedly used. In the drawing, a top field of a frame 1 is expressed by T1, a bottom field of the frame 1 by B1, a top field of a frame 2 by T2, and a bottom field of the frame 2 by B2.

FIG. 2 is a block diagram showing a conventional 3:2 pull-down image detection process. Referring to FIG. 2, if it is assumed that 10 fields detected by the 3:2 pull-down are F1, F2, F3, F4, F5, F6, F7, F8, F9, and F10, a film mode is detected by using the periodicity of a Summed Absolute Difference (SAD), which is 5. That is, if the SAD is obtained by the period of two fields, the SADs of F1−F3, F6−F8 become very small (If there is no noise, the SAD is even close to 0). The SADs are small, because the repeated field is subtracted from the original field. By using this regularity, in the film mode detection (3:2 pull down image detection), a difference of two fields at an interval of approximately 1/30 second is obtained for each pixel (204), an absolute value of difference is obtained (205), and then an intermediate data is created by adding up the absolute values to all the pixels (206). For example, if |F1−F3|=D1, |F2−F4|=D2, |F3−F4|=D3, . . . , SADs D1 and D6 have very small values and the rest SADs have large values. The SADs have a regularity of small, large, large, large, small.

In a case that there occurs an error in converting a picture, however, the SAD greatly increases. In consideration of this, limiting is performed with a threshold value M1 such that SADs larger than the threshold value M1 are substituted by the threshold value M1 (207). Through the limiting, the sequence of SAD D1, D2, D3, . . . has a waveform having the periodicity of 5 and amplitude width moving within a certain limitation. When such a waveform is passed through a digital threshold bandpass filter (208) having a center of 2π/5 and DC gain of 0, the waveform having ‘5’ periodicity has a signal similar to a sine wave having a predetermined amplitude width. Otherwise, the waveform having periodicity other than ‘5’ has approximately 0 signal output. Accordingly, calculating the power of the signal similar to the sine wave (209) would render a high power value if the signal has ‘5’ periodicity, and approximately 0 if the signal has the periodicity other than ‘5’. If the calculated power value is greater than a predetermined threshold value M2, it is determined that the signal is in a 3:2 pull-down image. Otherwise, it is determined that the signal is not in a 3:2 pull-down image (210).

The SAD between two fields of the 3:2 pull-down stream having a 1/30 second interval therebetween has ‘5’ periodicity, but the periodicity would brake as the noise is added. Also, when the limiting block removes a peak which appears when a picture is converted, the peak is removed by a predetermined value even in the case that the SAD has a small value according to the input stream, and accordingly, an incorrect value may be outputted. Also, the mode detection block has to have a predetermined threshold value, but in such a case, since a power is varied depending on the input stream, it is incorrect to set the threshold value to a fixed value.

Accordingly, even if the conventional 3:2 pull-down image detection method properly sets a threshold through many experiments, it cannot accurately detect a 3:2 pull-down image in a case that there is much noise in the input stream and many variations in the SAD.

Also, when there occurs a bad-edit in a process of editing the input image signal, the conventional 3:2 pull-down image detection method causes a comb in the de-interlaced image signal.

### SUMMARY OF THE INVENTION

The present invention has been developed in order to solve the above problems in the related art. Accordingly, an aspect of the present invention is to provide an image signal detecting apparatus and a method thereof capable of detecting a 2:2 pull-down image as well as a 3:2 pull-down image, and removing a comb caused by a bad-edit.

The above aspect is achieved by providing an image signal detecting apparatus, comprising a SAD calculation unit for calculating summed absolute differences (SADs) among a current field (n), a previous field (n−1), and a next field (n+1) with respect to consecutively input image signals with ‘n’ being n=1, 2, 3, . . . , a pull-down image detection unit for detecting a pull-down image based on the calculated SADs, a still image determining unit for determining whether the input image signal is a still image or not based on the calculated SADs and absolute change amounts among the SADs, a bad-edit detection unit for detecting a bad-edit in the detected pull-down image, and a decision unit for deciding whether the input image signal is the pull-down image or not based on the result of detecting the pull-down image, the result of determining whether the input image signal is a still image by the sill image judgment unit, and the result of detecting the occurrence of the bad-edit.

The pull-down image detection unit comprises a 3:2 pull-down image detection unit for detecting a 3:2 pull-down image, and a 2:2 pull-down image detection unit for detecting a 2:2 pull-down image. The 3:2 pull-down image detection unit comprises a main detection unit for detecting the 3:2 pull-down image based on a SAD between fields spaced from each other by 1 period, and a sub detection unit for detecting the 3:2 pull-down image based on an absolute change amount with respect to the SAD between the 1 period-spaced fields. In this case, the 3:2 pull-down image detection unit detects the 3:2 pull-down image by generating patterns of the SADs between the 1 period-spaced fields and patterns of the absolute change amounts, and comparing the patterns of the SADs and the patterns of the absolute change amounts with a basic pattern of the 3:2 pull-down image.

The 2:2 pull-down image detection unit comprises a main detection unit for detecting the 2:2 pull-down image based on a SAD between consecutive fields, and a sub-detection unit for detecting the 2:2 pull-down image based on an absolute change amount with respect to the SAD between the consecutive fields. In this case, the 2:2 pull-down image detection unit detects the 2:2 pull-down image by generating patterns of the SADs between the consecutive fields and patterns of the absolute change amounts, and comparing the patterns of the SADs and the patterns of the absolute change amounts with a basic pattern of the 2:2 pull-down image.

Meanwhile, an image signal detecting method comprising a SAD calculating step of calculating SADs among a current field (n), a previous field (n−1), and a next field (n+1) with respect to consecutively input image signals with ‘n’ being n=1, 2, 3, . . . , a pull-down image detection step of detecting a pull-down image based on the calculated SADs, a still image judgment step of judging whether the input image signal is a still image based on the calculated SADs and absolute change amounts among the SADs, a bad-edit detection step of detecting a bad-edit in the detected pull-down image, and a pull-down image decision step of deciding whether the input image signal is the pull-down image or not based on the result of detecting the pull-down image, the result of judging whether the input image signal is a still image by the still image judgment step, and the result of detecting the occurrence of the bad-edit.

The pull-down image detection step comprises a 3:2 pull-down image detection step of detecting a 3:2 pull-down image, and a 2:2 pull-down image detection step of detecting a 2:2 pull-down image.

The 3:2 pull-down image detection step comprises a main detection step of detecting the 3:2 pull-down image based on a SAD between fields spaced from each other by 1 period, and a sub-detection step of detecting the 3:2 pull-down image based on an absolute change amount with respect to the SAD between the 1 period-spaced fields.

The 2:2 pull-down image detection step comprises a main detection step of detecting the 2:2 pull-down image based on a SAD between consecutive fields, and a sub-detection step of detecting the 2:2 pull-down image based on an absolute change amount with respect to the SAD between the consecutive fields.

The main detection step may comprise the steps of consecutively storing the SADs between the 1 period-spaced fields, calculating a first threshold value using the consecutively stored SADs, generating patterns of the SADs according to the calculated first threshold value, consecutively storing the patterns of the SADs, and comparing the stored patterns of the SADs with a predetermined basic pattern of the SAD. The main detection step detects the 3:2 pull-down image according to the result of the comparison by the SAD pattern comparison step.

Also, the main detection step comprises the steps of consecutively storing the SADs between consecutive fields, calculating a first threshold value using the consecutively stored SADs, generating patterns of the SADs according to the calculated first threshold value, consecutively storing the patterns of the SADs, and comparing the stored patterns of the SADs with a predetermined basic pattern of the SAD. The main detection step detects the 2:2 pull-down image according to the result of the comparison by the SAD pattern comparison step.

Also, the sub-detection step comprises the steps of consecutively storing absolute change amounts with respect to the SADs between the 1 period-spaced fields, calculating a second threshold value using the consecutively stored absolute change amounts, generating patterns of the absolute change amounts according to the calculated second threshold value, consecutively storing the patterns of the absolute change amounts, and comparing the patterns of the stored absolute change amounts with a predetermined basic pattern of the absolute change amounts. The sub detection step detects the 3:2 pull-down image according to the result of the comparison by the absolute change amount pattern comparison step.

Also, the sub-detection step comprises the steps of consecutively storing absolute change amounts with respect to the SADs between the consecutive fields, calculating a second threshold value using the consecutively-stored absolute change amounts, generating patterns of the absolute change amounts according to the calculated second threshold value, consecutively storing the patterns of the absolute change amounts, and comparing the patterns of the stored absolute change amounts with a predetermined basic pattern of the absolute change amount. The sub-detection step detects the 2:2 pull-down image according to the result of the comparison by the absolute change amount pattern comparison step.

Accordingly, the image signal detection apparatus is capable of accurately detecting the 2:2 pull-down image as well as the 3:2 pull-down image and removing a comb caused by the bad-edit.

### BRIEF DESCRIPTION OF THE DRAWINGS

The above aspect and other advantages of the present invention will become more apparent by describing in detail the exemplary embodiments thereof with reference to the attached drawings, in which:

FIG. 1 is a view explaining a 3:2 pull-down process;

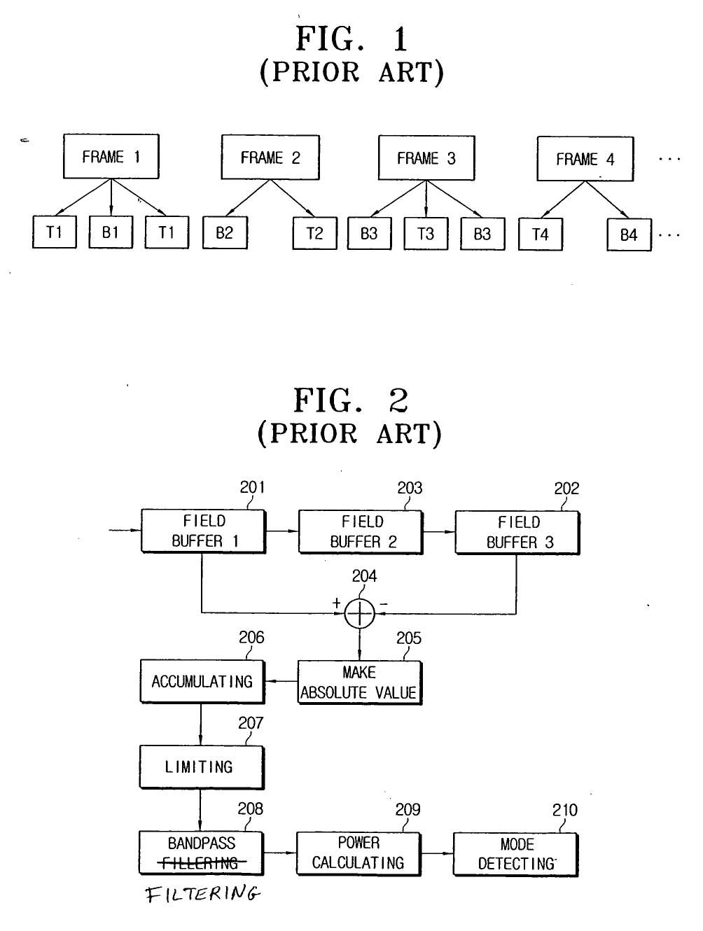

FIG. 2 is a block diagram showing a conventional 3:2 pull-down image detection process;

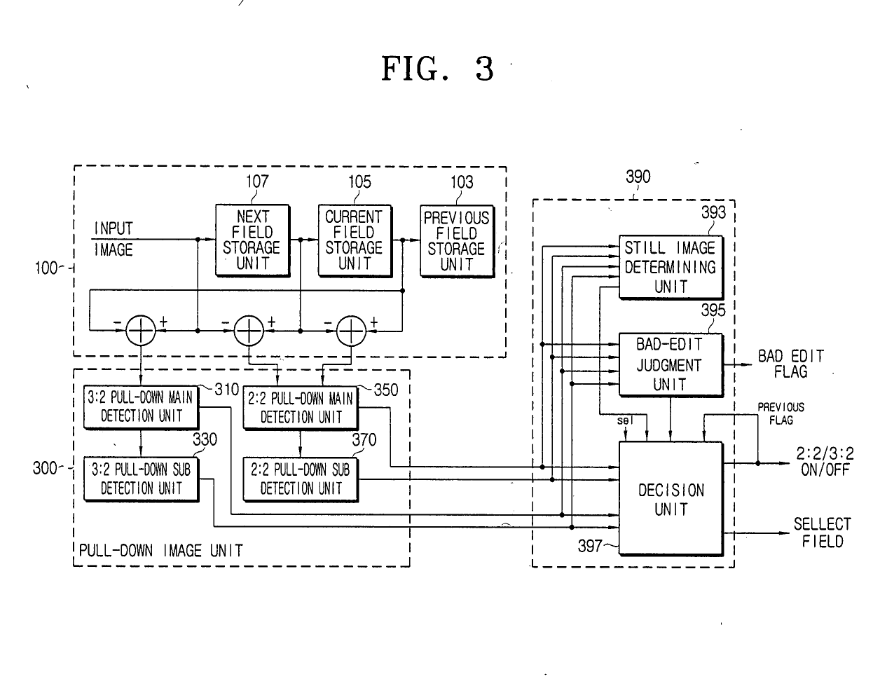

FIG. 3 is a block diagram showing an image signal detecting apparatus according to the present invention;

FIG. 4 is a block diagram showing the 3:2 pull-dovn main detection unit and the 3:2 pull-down sub-detection unit of FIG. 3;

FIG. 5 is a block diagram showing the first threshold value calculation unit of the 3:2 pull-down main detection unit of FIG. 3;

FIG. 6 is a block diagram showing the second threshold value calculation unit of the 3:2 pull-down sub-detection unit of FIG. 3;

FIG. 7 is a block diagram showing the 2:2 pull-down main detection unit and the 2:2 pull-down sub-detection unit of FIG. 3;

FIG. 8 is a block diagram showing the first threshold value calculation unit of the 2:2 pull-down main detection unit of FIG. 3;

FIG. 9 is a block diagram showing the second threshold value calculation unit of the 2:2 pull-down sub-detection unit of FIG. 3;

FIG. 10 is a flowchart showing an image signal detecting method performed by the apparatus of FIG. 3;

FIG. 11 is a flowchart showing a 3:2 pull-down image detecting method performed by the 3:2 pull-down main detection unit of FIG. 3;

FIG. 12 is a flowchart showing a 3:2 pull-down image detecting method performed by the 3:2 pull-down sub-detection unit of FIG. 3;

FIG. 13 is a flowchart showing a 2:2 pull-down image detecting method performed by the 2:2 pull-down main detection unit of FIG. 3;

FIG. 14 is a flowchart showing a 2:2 pull-down image detecting method performed by the 2:2 pull-down sub-detection unit of FIG. 3;

FIGS. 15A to 15F are views showing examples of a bad-edit occurring in the 3:2 pull-down image to explain a bad-edit detecting method performed by the bad-edit detection unit of FIG. 3; and

FIGS. 16A to 16D are views showing examples of a bad-edit occurring in the 2:2 pull-down image to explain a bad-edit detecting method performed by the bad-edit detection unit of FIG. 3.

### DETAILED DESCRIPTION OF THE ILLUSTRATIVE, NON-LIMITING EMBODIMENTS

Now, an image signal detecting apparatus and a method thereof according to exemplary embodiments of the present invention will be described in detail with reference to the annexed drawings in which like reference numerals refer to like elements.

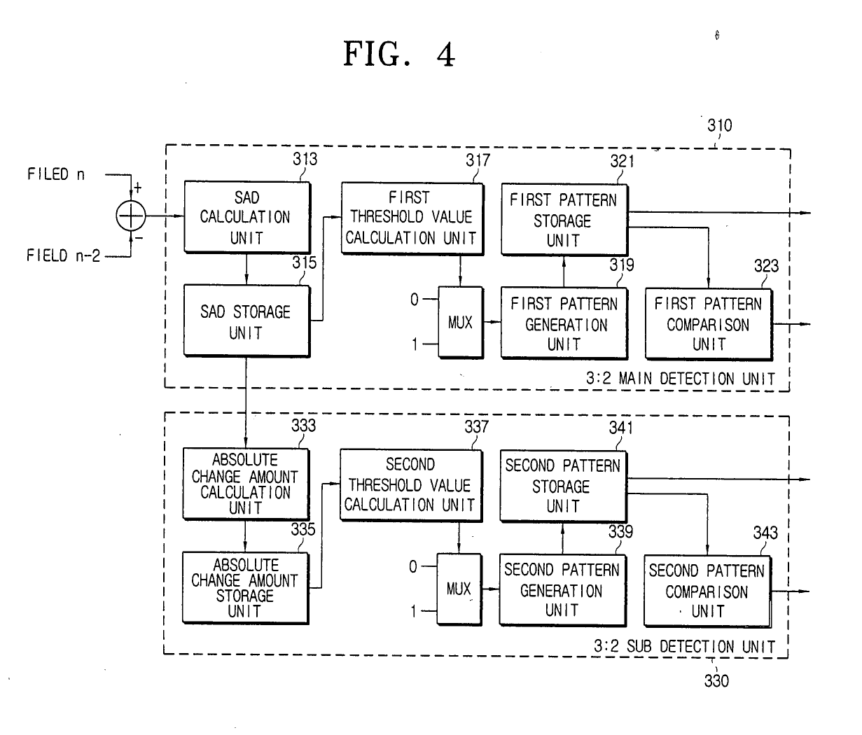

FIG. 3 is a block diagram showing a video signal detecting apparatus according to an embodiment of the present invention. Referring to FIG. 3, the video signal detecting apparatus includes a summed absolute difference (SAD) calculation unit 100, a pull-down image detection unit 300, and a pull-down sequence decision unit 390.

The SAD calculation unit 100 includes a previous field storage unit 103 for storing a previous field (n−1) which is inputted immediately before -a currently-input video signal, a current field storage unit 105 for storing a currently-input field (n), and a next field storage unit 107 for storing a next field (n+1) following the current field (n). The SAD calculation unit 100 obtains pixel values with respect to the fields (n−1), (n), (n+1) stored in the previous field storage unit 103, the current field storage unit 105, and the next field storage unit 107, respectively, and calculates a difference of the pixel values between the fields, i.e., calculates summed absolute differences (SADs).

The pull-down image detection unit 300 includes a 3:2 pull-down main detection unit 310, a 3:2 pull-down sub detection unit 330, a 2:2 pull-down main detection unit 350, and a 2:2 pull-down sub-detection unit 370. The 3:2 pull-down main detection unit 310 detects a 3:2 pull-down image based on a SAD between fields spaced from each other by one period. The 3:2 pull-down sub detection unit 330 detects a 3:2 pull-down image based on an absolute change amount with respect to the SAD between the fields spaced from each other by one period. Also, the 2:2 pull-down main detection unit 350 detects a 2:2 pull-down image based on a SAD between consecutive fields. The 2:2 pull-down sub-detection unit 370 detects a 2:2 pull-down image based on an absolute change amount with respect to the SAD between the consecutive fields.

The pull-down sequence decision unit 390 includes a still image determining unit 393, a bad-edit detection unit 395, and a decision unit 397. The still image determining unit 393 determines if an input video signal is a still image based on the SADs and the absolute change amounts between the SADs calculated by the SAD calculation unit 100. The bad-edit detection unit 395 detects whether there occurs a bad-edit in the pull-down image detected by the 3:2 pull-down main detection unit 310, the 3:2 pull-down sub-detection unit 330, the 2:2 pull-down main detection unit 350, and the 2:2 pull-down sub detection unit 370, respectively. The decision unit 397 decides whether the video signal is a pull-down image or not based on the result of detecting the pull-down image by the pull-down image unit 300, the result of determining the still image by the still image determining unit 393, and the result of detecting the occurrence of the bad-edit by the bad-edit judgment unit 395, respectively.

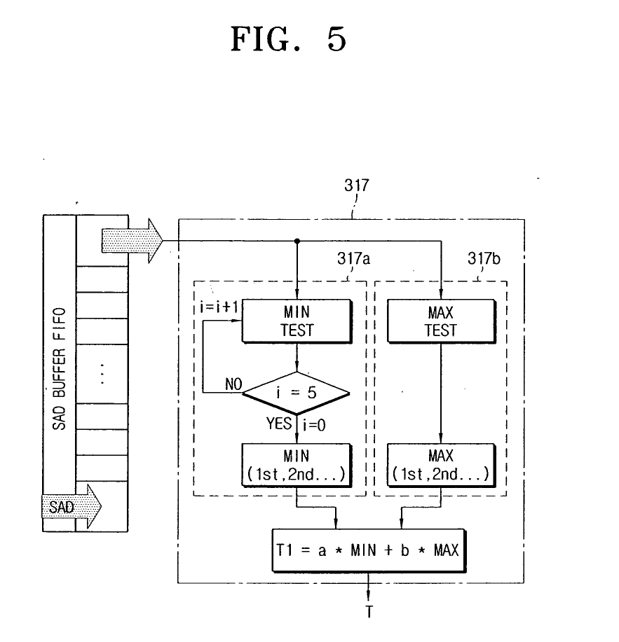

FIG. 4 is a block diagram showing the 3:2 pull-down main detection unit and the 3:2 pull-down sub-detection unit of FIG. 3. Referring to FIG. 4, the 3:2 pull-down main detection unit 310 includes a SAD calculation unit 313, a SAD storage unit 315, a first threshold value calculation unit 317, a first pattern generation unit 319, a first pattern storage unit 321, and a first pattern comparison unit 323.

The SAD calculation unit 313 calculates a SAD between fields of the video signal which are spaced from each other by one period. That is, the SAD calculation unit calculates a SAD between a previous field (n−1) of the input video signal and a next field (n+1). The calculation of SAD between the previous field (n−1) and the next field (n+1) by the SAD calculation unit 313 is repeatedly performed with respect to the fields of the consecutively input video signals. The SAD storage unit 315 consecutively stores the SADs calculated by the SAD calculation unit 313. In order to consecutively store the calculated SADs, the SAD storage unit 315 is implemented by a predetermined number of FIFO (First-In First-Out) buffers. The first threshold value calculation unit 317 calculates a first threshold value using the stored SADs. The first pattern generation unit 319 generates patterns of the SADs according to the calculated first threshold value. The first pattern storage unit 321 consecutively stores the patterns of the SADs generated by the first pattern generation unit 319. In order to consecutively store the SAD patterns generated by the first pattern generation unit 319, the first pattern storage unit 321 is implemented by a predetermined number of FIFO buffers. The first pattern comparison unit 323 compares the pattern of the SAD stored in the first pattern storage unit 321 with a predetermined basic pattern of the SAD.

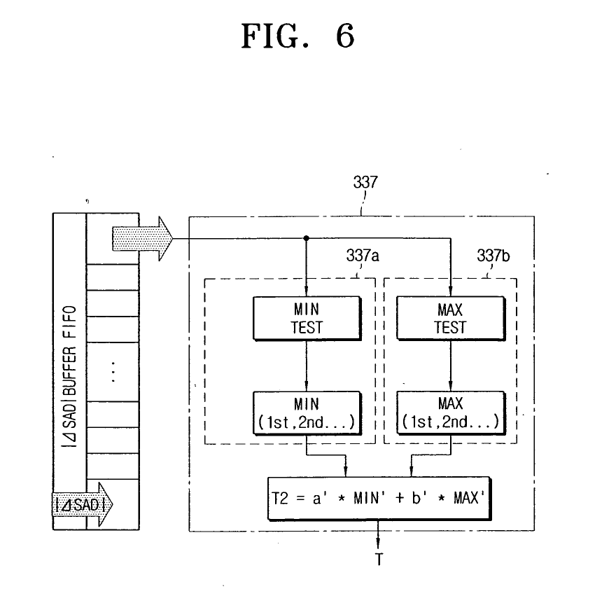

Also, the first threshold value calculation unit 317 includes a first minimum value detection unit 317a and a first maximum value detection unit 317b (see FIG. 5). The first minimum value detection unit 317a detects a minimum value of the continuous 5 SADs stored in the SAD storage unit 315. The first maximum value detection unit 317b detects a maximum value of the continuous 5 SADs. In this case, since the SAD with respect to the fields of the 3:2 pull-down image has a minimum value once for 5 periods, the first minimum value detection unit 317a detects a minimum value once for 5 periods and thus can be implemented to reduce a load to the operations.

Meanwhile, the sub-detection unit 330 includes an absolute change amount calculation unit 333, an absolute change amount storage unit 335, a second threshold value calculation unit 337, a second pattern generation unit 339, a second pattern storage unit 341, and a second pattern comparison unit 343.

The absolute change amount calculation unit 333 calculates an absolute change amount between the SADs calculated by the SAD calculation unit 313. The absolute change amount storage unit 335 consecutively stores the calculated absolute change amounts. The second threshold value calculation unit 337 calculates a second threshold value using the stored absolute change amounts. The second pattern generation unit 339 generates patterns of the absolute change amounts according to the calculated second threshold value. The second pattern storage unit 341 consecutively stores the patterns of the absolute change amounts generated by the second pattern generation unit 339. In an exemplary embodiment, the absolute change amount storage unit 335 and the second pattern storage unit 341 are implemented by FIFO buffers in the same manner as the SAD storage unit 315 and the first pattern storage unit 321.

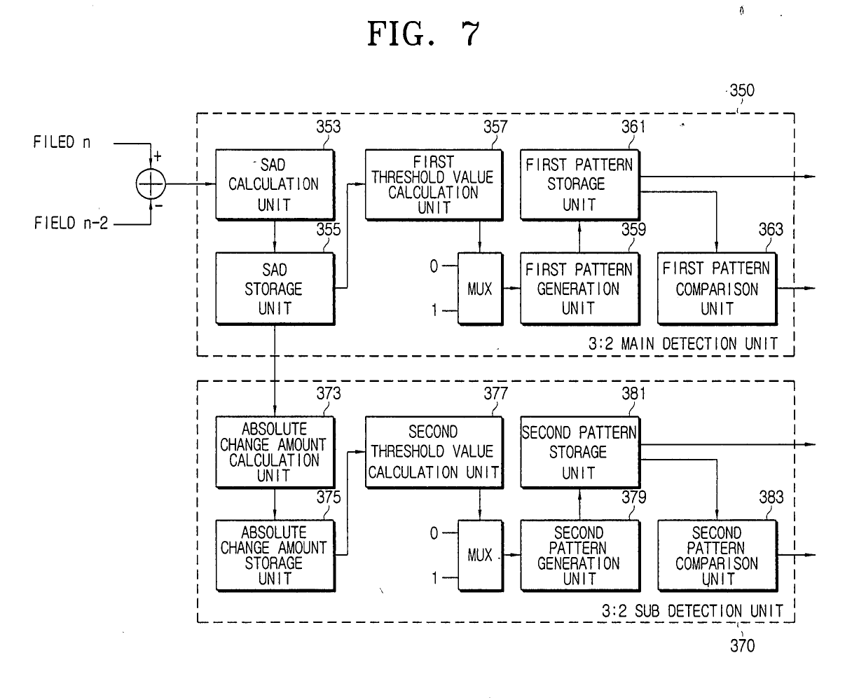

The second pattern comparison unit 343 compares the pattern of the absolute change amount stored in the second pattern storage unit 341 with a predetermined basic pattern of the absolute change amount. Also, the second threshold value calculation unit 337 includes a second minimum value detection unit 337a and a second maximum value detection unit 337b (see FIG. 6). The second minimum value detection unit 337a detects a minimum value of 5 continuous absolute change amounts stored in the absolute change amount storage unit 335. The second maximum value detection unit 337b detects a maximum value of the 5 continuous absolute change amounts. In an exemplary embodiment, the second pattern storage unit 341 is implemented so that the absolute change amounts between the SADs stored in the first pattern storage unit 321 are consecutively stored in the second pattern storage unit 341. In this embodiment, the first threshold value calculation unit 317 of the 3:2 pull-down main detection unit 310 and the second threshold value calculation unit 337 of the 3:2 pull-down sub-detection unit 330 detect the maximum value and the minimum value with respect to the 5 consecutive values only, in consideration of the fact that the basic pattern of the SADs and the absolute change amounts with respect to the 3:2 pull-down image has the repeated 5 consecutive values. However, this should not be considered as limiting. The first threshold value calculation unit 317 of the 3:2 pull-down main detection unit 310 and the second threshold value calculation unit 337 of the 3:2 pull-down sub detection unit 330 may detect a minimum value and a maximum value from more than 5 consecutive values.

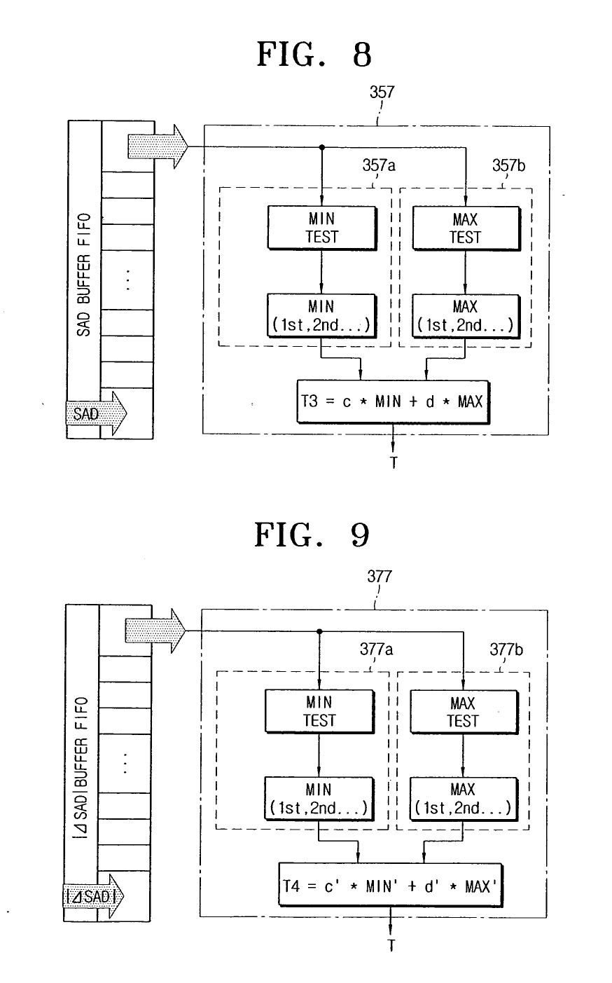

FIG. 7 is a block diagram showing the 2:2 pull-down main detection unit and the 2:2 pull-down sub detection unit of FIG. 3. Referring to FIG. 7, the 2:2 pull-down main detection unit 350 includes a SAD calculation unit 353, a SAD storage unit 355, a first threshold value calculation unit 357, a first pattern generation unit 359, a first pattern storage unit 361, and a first pattern comparison unit 363.

The SAD calculation unit 353 calculates a SAD between consecutive fields of a video signal. That is, the SAD calculation unit 353 calculates a SAD between a previous field (n−1) and a current field (n) with respect to a video signal. The SAD storage unit 355 consecutively stores the SADs calculated by the SAD calculation unit 353. In order to consecutively store the calculated SADs, the SAD storage unit 355 is implemented by a predetermined number of FIFO buffers. The first threshold value calculation unit 357 calculates a first threshold value using the stored SADs. The first pattern generation unit 359 generates patterns of the SADs according to the calculated first threshold value. The first pattern storage unit 361 consecutively stores the patterns of the SADs generated by the first pattern generation unit 359. In order to consecutively store the SAD patterns generated by the first pattern generation unit 359, the first pattern storage unit 361 is implemented by a predetermined number of FIFO buffers. The first pattern comparison unit 363 compares the pattern of the SAD stored in the first pattern storage unit 361 with a predetermined basic pattern of the SAD.

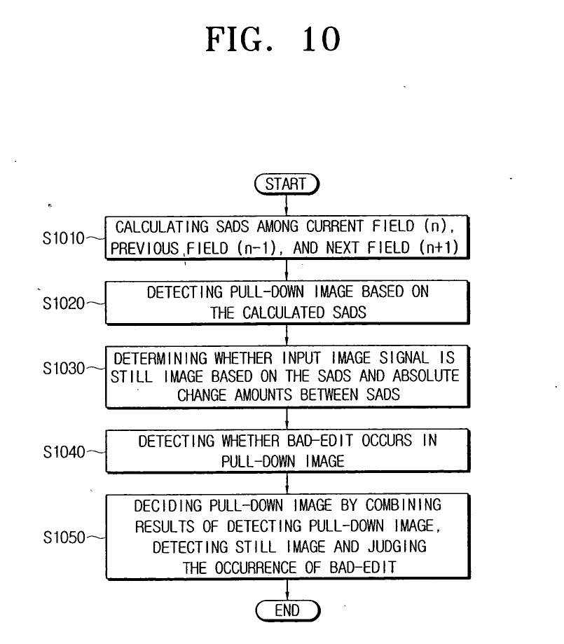

Also, the first threshold value calculation unit 357 includes a first minimum value detection unit 357a and a first maximum value detection unit 357b (see FIG. 8). The first minimum value detection unit 357a detects a minimum value of the SADs with respect to a specified section of the SADs stored in the SAD storage unit 355. The first maximum value detection unit 357b detects a maximum value of the SADs with respect to the specified section. In this case, since the 2:2 pull-down sequence has the minimum value of the SADs between two fields of the same frame and has the maximum value of the SADs between consecutive fields of two adjacent frames, the first minimum value detection unit 357a and the first maximum value detection unit 357b can be implemented to detect the minimum value and the maximum value with respect to the SADs between the spaced fields. In an exemplary embodiment, the first minimum value detection unit 357a and the first maximum value detection unit 357b are implemented so that the first minimum value detection unit 357a detects the SAD between the fields of the same frame, and the first maximum value detection unit 357b detects the SAD between the fields of the adjacent frames.

Meanwhile, the sub-detection unit 370 includes an absolute change amount calculation unit 373, an absolute change amount storage unit 375, a second threshold value calculation unit 377, a second pattern generation unit 379, a second pattern storage unit 381, and a second pattern comparison unit 383. The absolute change amount calculation unit 373 calculates an absolute change amount between the SADs calculated by the SAD calculation unit 353. The absolute change amount storage unit 375 consecutively stores the calculated absolute change amounts. The second threshold value calculation unit 377 calculates a second threshold value using the stored absolute change amounts. The second pattern generation unit 379 generates patterns of the absolute change amounts according to the calculated second threshold value. The second pattern storage unit 381 consecutively stores the patterns of the absolute change amounts generated by the second pattern generation unit 379. In an exemplary embodiment, the absolute change amount storage unit 375 and the second pattern storage unit 381 are implemented by FIFO buffers in the same manner as the SAD storage unit 355 and the first pattern storage unit 361.

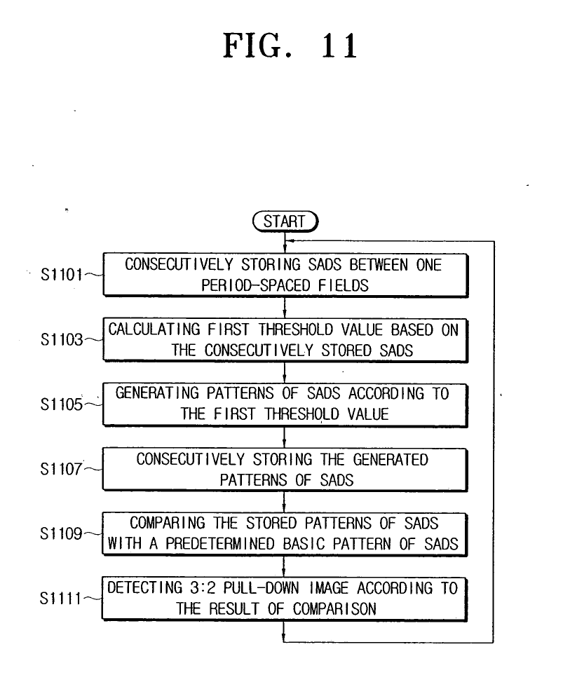

The second pattern comparison unit 383 compares the pattern of the absolute change amount stored in the second pattern storage unit 381 with a predetermined basic pattern of the absolute change amount. Also, the second threshold value calculation unit 387 includes a second minimum value detection unit 377a and a second maximum value detection unit 377b (see FIG. 9) The second minimum value detection unit 377a detects a minimum value of the absolute change amounts with respect to a specified section of the absolute change amounts stored in the absolute change amount storage unit 375. The second maximum value detection unit 377b detects a maximum value of the absolute change amounts with respect to the specified section. In an exemplary embodiment, the second pattern storage unit 381 is implemented so that the absolute change amounts between the SADs stored in the first pattern storage unit 361 are consecutively stored in the second pattern storage unit 381.

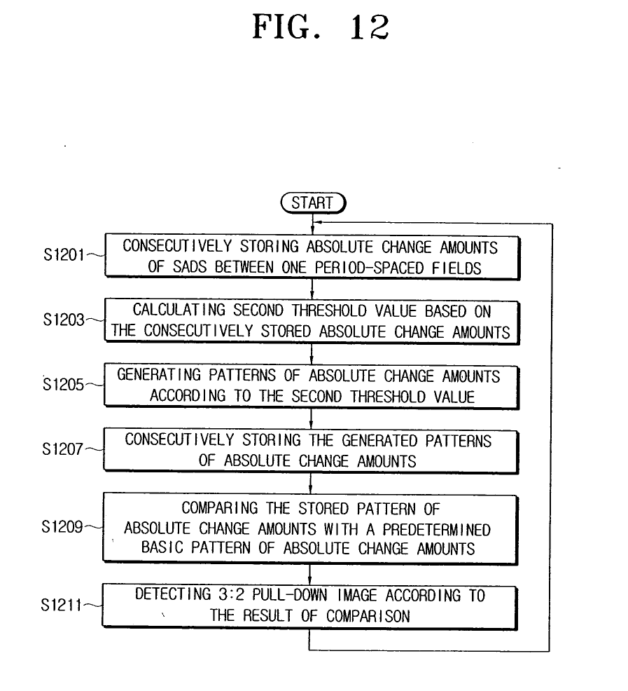

FIG. 10 is a flowchart illustrating a video signal detecting method performed by the apparatus of FIG. 3. With reference to the drawings, the operation of the video signal detecting apparatus according to the present invention will be described in greater detail hereinbelow.

Referring to FIG. 10, the SAD calculation unit 100 obtains pixel values of fields stored in the previous field storage unit, the current field storage unit, and the next field storage unit and calculates differences of the pixel values between the fields, i.e., SAD between the previous field (n−1) and the current field (n), SAD between the current field (n) and the next field (n+1), and SAD between the previous field (n−1) and the next field (n+1) (S1010). The pull-down image detection unit 300 detects a pull-down image with respect to an input video signal based on the calculated SADs (S1020). In here, the pull-down image detection process performed by the pull-down image detection unit 300 is divided into a 3:2 pull-down image detection process and a 2:2 pull-down image detection process.

The still image determining unit 393 determines whether the input video signal is a still image based on the calculated SADs and the absolute change amounts between the SADs (S1030). For example, if it is defined that the difference of pixel values between the previous field (n−1) and the current field (n) is SADI and the difference of pixel values between the current field (n) and the next field (n+1) is SAD2, the absolute change amount between the SADs is an absolute value of pixel values between the SAD1 and SAD2.

The bad-edit detection unit 395 detects whether there occurs a bad-edit in an editing process with respect to the input video signal (S1040). The detection by the bad-edit detection unit 395 will be described in detail later.

The pull-down sequence decision unit 390 decides the video signal as a pull-down image according to the combination of the result of detecting a pull-down image by the 3:2 pull-down main detection unit 310, the 3:2 pull-down sub-detection unit 330, the 2:2 pull-down main detection unit 350, and the 2:2 pull-down sub-detection unit 370 of the pull-down image detection unit 300, the result of detecting a still image by the still image determining unit 393, and the result of detecting the occurrence of the bad-edit by the bad-edit detection unit 395, respectively (S150). The method of detecting a pull-down image of a video signal performed by the pull-down sequence decision unit 390 will be described later.

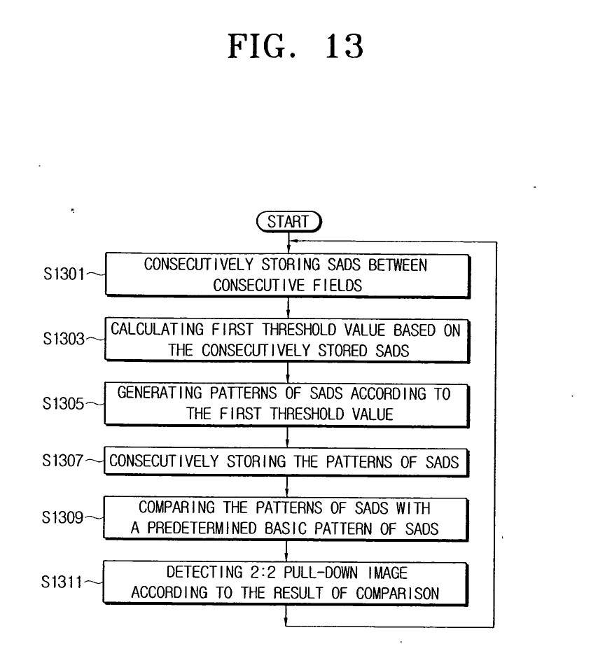

FIG. 11 is a flowchart showing a 3:2 pull-down image detection method performed by the 3:2 pull-down main detection unit of FIG. 3. Referring to FIG. 11, the SAD calculation unit 313 calculates a SAD between one period-spaced fields, i.e., a SAD between the previous field (n−1) and the next field (n+1). The SAD storage unit 315 consecutively stores the SADs calculated by the SAD calculation unit 313 (S1101). The first threshold value calculation unit 317 calculates a first threshold value by using the SADs consecutively stored in the SAD storage unit 315. In this case, the first minimum value detection unit 317a of the first threshold calculation unit 317 detects a minimum value of 5 continuous SADs stored in the SAD storage unit 315. At this time, since a 3:2 pull-down image has one same field for 5 fields, the first minimum value detection unit 317a may be implemented so as to detect the minimum value only once for 5 fields. Also, the first maximum value detection unit 317b of the first threshold value calculation unit 317 detects a maximum value of 5 continuous SADs stored in the SAD storage unit 315. The first threshold value calculation unit 317 calculates the first threshold value based on the minimum value and the maximum value of the SADs detected by the first minimum value detection unit 317a and the first maximum value detection unit 317b, and the calculation of the first threshold value is performed by the following equation.
T1=a×MIN+b×MAX [Equation 1]

Here, T1 denotes the first threshold value of a pull-down image field, a and b are certain values keeping a+b=1, MIN denotes the minimum value of the 5 continuous SADs, and MAX denotes the maximum value of the continuous 5 SADs.

The first pattern generation unit 319 generates patterns of the SADs stored in the SAD storage unit 315 according to the first threshold value calculated by the first threshold value calculation unit 317 (step S1105). In this case, the first pattern generation unit 319 compares the SAD with the first threshold value calculated by the first threshold value calculation unit 317, and generates ‘1’ if the SAD is larger than the first threshold value. Otherwise, the first pattern generation unit 319 generates ‘0’.

The first pattern storage unit 321 consecutively stores the patterns of the SADs generated by the first pattern generation unit 309 (S1107). The first pattern comparison unit 323 compares the pattern of the SAD stored in the first pattern storage unit 321 with the predetermined basic pattern of the SAD (step S1109). Here, the basic pattern of the SAD means the basic pattern of the SAD of the 3:2 pull-down image, and appears with five types. That is, the five types of the basic pattern of the SAD are 0111101111, 1011110111, 1101111011, 1110111101, and 1111011110. The 3:2 pull-down main detection unit 310 detects the 3:2 pull-down image according to a result of comparison by the first pattern comparison unit 323 (step S1111). That is, if the pattern of the SAD stored in the first pattern storage unit 321 is identical to the basic pattern of the SAD, the 3:2 pull-down main detection unit 310 decides the input video signal to be a 3:2 pull-down image. This process of detecting the 3:2 pull-down image is repeatedly performed with respect to the input image signal. In the case that the picture is abruptly changed, the 3:2 pull-down image is detected by adaptively changing the threshold value, and thus it can properly cope with the changed picture.

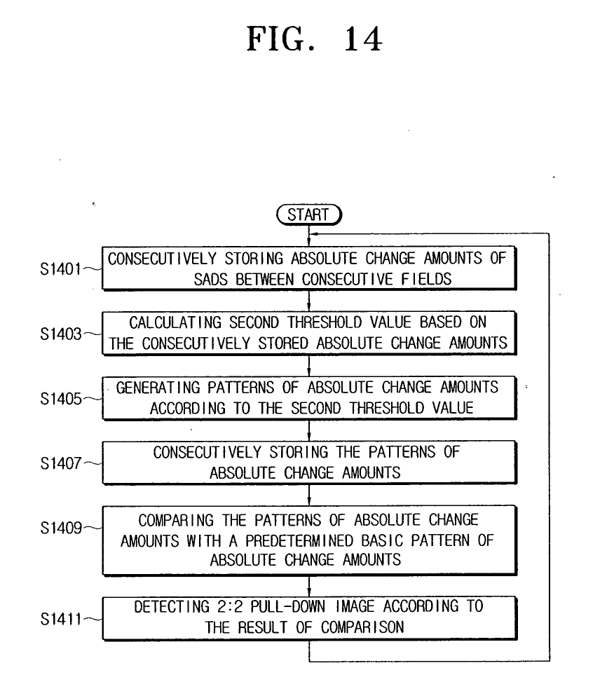

FIG. 12, is a flowchart showing a 3:2 pull-down image detection method performed by the 3:2 pull-down sub-detection unit of FIG. 3. Referring to FIG. 12, the absolute change amount calculation unit 333 calculates an absolute change amount between SADs calculated by the SAD calculation unit 313 of the 3:2 pull-down main detection unit 310 between one period-spaced fields. That is, if it is defined that the difference of pixel values between the previous field (n−1) and the next field (n+1) is SAD3 and the difference of pixel values between the current field n and the next field (n+2) is SAD4, the absolute change amount calculation unit 333 calculates an absolute value of the difference between the SAD3 and the SAD4. The absolute change amount storage unit 335 consecutively stores the absolute change amounts calculated by the absolute change amount calculation unit 333 (S1201). The second threshold value calculation unit 337 calculates a second threshold value by using the absolute change amount stored in the absolute change amount storage unit 335 (S1203). In this case, the second minimum value detection unit 337a of the second threshold value calculation unit 337 detects a minimum value with respect to 5 continuous absolute change amounts from the absolute change amounts stored in the absolute change amount storage unit 335. Also, the second threshold value calculation unit 337 detects a maximum value with respect to the 5 continuous absolute change amounts from the absolute change amounts stored in the absolute change amount storage unit 335. The second threshold value calculation unit 337 calculates a second threshold value based on the minimum value and the maximum value of the absolute change amounts detected by the second minimum value detection unit 337a and the second maximum value detection unit 337b, and the calculation of the second threshold value is performed by the following equation.
T2=a′×MIN′+b′×MAX′ [Equation 2]

Here, T2 denotes the second threshold value with respect to the field of the 3:2 pull-down image, a′ and b′ are certain values keeping a′+b′=1, MIN′ denotes the minimum value of the 5 continuous absolute change amounts, and MAX′ denotes the maximum value of the 5 continuous absolute change amounts.

The second pattern generation unit 339 generates patterns of the absolute change amounts stored in the absolute change amount storage unit 335 according to the second threshold value calculated by the second threshold value calculation unit 337 (step S1205). In this case, the second pattern generation unit 339 compares the absolute change amount with the second threshold value calculated by the second threshold value calculation unit 337, and generates ‘1’ if the absolute change amount is larger than the second threshold value. Otherwise, the second pattern generation unit 359 generates ‘0’.

The second pattern storage unit 341 consecutively stores the patterns of the absolute change amounts generated by the second pattern generation unit 339 (step S1207). The second pattern comparison unit 343 compares the pattern of the absolute change amount stored in the second pattern storage unit 341 with the predetermined basic pattern of the absolute change amount (step S1209). Here, the basic pattern of the absolute change amount means the basic pattern of the absolute change amount of the 3:2 pull-down image, and appears with five types. That is, the five types of the basic pattern of the absolute change amount are 1000110001, 1100011000, 0110001100, 0011000110, and 0001100011. The 3:2 pull-down sub detection unit 330 detects a 3:2 pull-down image according to a result of comparison by the second pattern comparison unit 343. That is, if the pattern of the absolute change amount stored in the second pattern storage unit 341 is identical to the basic pattern, the 3:2 pull-down detection unit 330 decides that the input image signal is a 3:2 pull-down image.

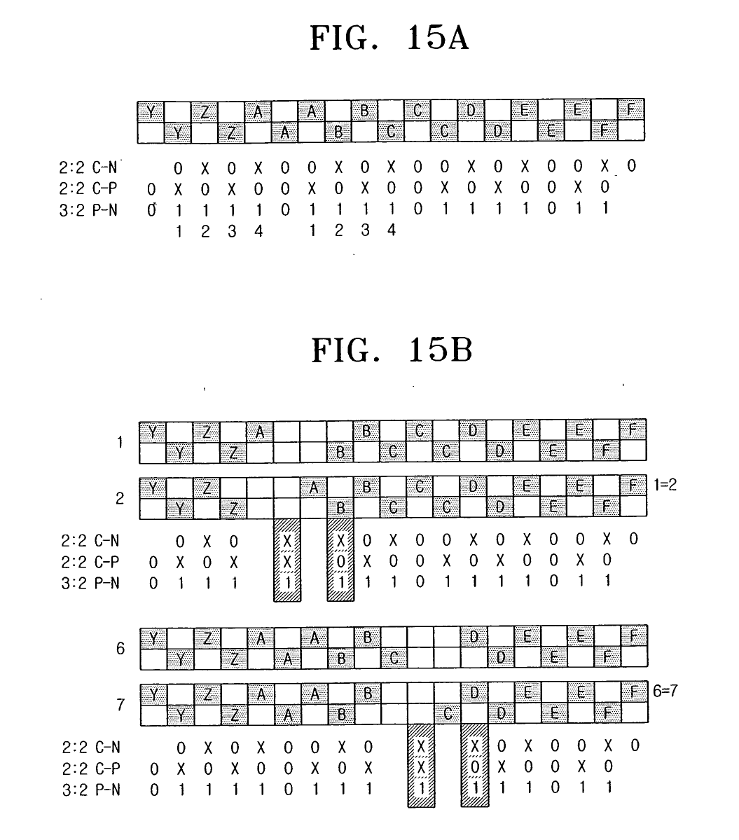

FIG. 13 is a flowchart showing a 2:2 pull-down image detection method performed by the 2:2 pull-down main detection unit of FIG. 3. Referring to FIG. 13, the SAD calculation unit 353 calculates SADs between consecutive fields, i.e., a SAD between the previous field (n−1) and the current field (n) and a SAD between the current field (n) and the next field (n+1). The SAD storage unit 355 consecutively stores the SADs calculated by the SAD calculation unit 353 (S1301). The first threshold value calculation unit 357 calculates a first threshold value by using the SADs consecutively stored in the SAD storage unit 355 (S1303). In this case, the first minimum value detection unit 357a of the first threshold value calculation unit 357 detects a minimum value of the SADs with respect to a specified section of the SADs stored in the SAD storage unit 355. The first maximum value detection unit 357b of the first threshold value calculation unit 357 detect a maximum value of the SADs with respect to the specified section of the SADs stored in the SAD storage unit 355. At this time, since it is generally the case that the SAD between the fields of the same frame has a small value, the first minimum value detection unit 357a may be implemented so as to detect the minimum value by searching for only the SAD between the fields of the same frame. Also, since it is generally the case that the SAD between the fields of the adjacent frames is changed, the first maximum value detection unit 357b may be implemented so as to detect the maximum value by searching for only the SAD between the fields of the adjacent frames.

The first threshold value calculation unit 357 calculates the first threshold value based on the minimum value and the maximum value of the SADs detected by the first minimum value detection unit 357a and the first maximum value detection unit 357b, and the calculation of the first threshold value is performed by the following equation.
T3=c×MIN+d×MAX [Equation 3]

Here, T3 denotes the first threshold value with respect to the field of the 2:2 pull-down image, c and d are certain values keeping c+d=1, MIN denotes the minimum value of the SADs in a specified section, and MAX denotes the maximum value of the SADs in the specified section.

The first pattern generation unit 359 generates patterns of the SADs stored in the SAD storage unit 355 according to the first threshold value calculated by the first threshold value calculation unit 357 (step S1305). In this case, the first pattern generation unit 359 compares the SAD with the first threshold value calculated by the first threshold value calculation unit 357, and generates ‘1’ if the SAD is larger than the first threshold value. Otherwise, the first pattern generation unit 309 generates ‘0’.

The first pattern storage unit 361 consecutively stores the patterns of the SADs generated by the first pattern generation unit 359 (step S1307). The first pattern comparison unit 363 compares the pattern of the SAD stored in the first pattern storage unit 361 with the predetermined basic pattern of the SAD (step S1309). Here, the basic pattern of the SAD means the basic pattern of the SAD of the 2:2 pull-down image, and appears with two types. That is, the two types of the basic pattern of the SAD are 0101010101 and 1010101010. The 2:2 pull-down main detection unit 350 detects the 2:2 pull-down image according to a result of comparison by the first pattern comparison unit 363 (step S1311). That is, if the pattern of the SAD stored in the first pattern storage unit 361 is identical to the basic pattern of the SAD, the 2:2 pull-down main detection unit 350 decides that the input image signal is a 2:2 pull-down image. This process of detecting the 2:2 pull-down image is repeatedly performed with respect to the input image signal. In the case that the picture is abruptly changed, the 2:2 pull-down image is detected by adaptively changing the threshold value, and thus it can properly cope with the changed picture.

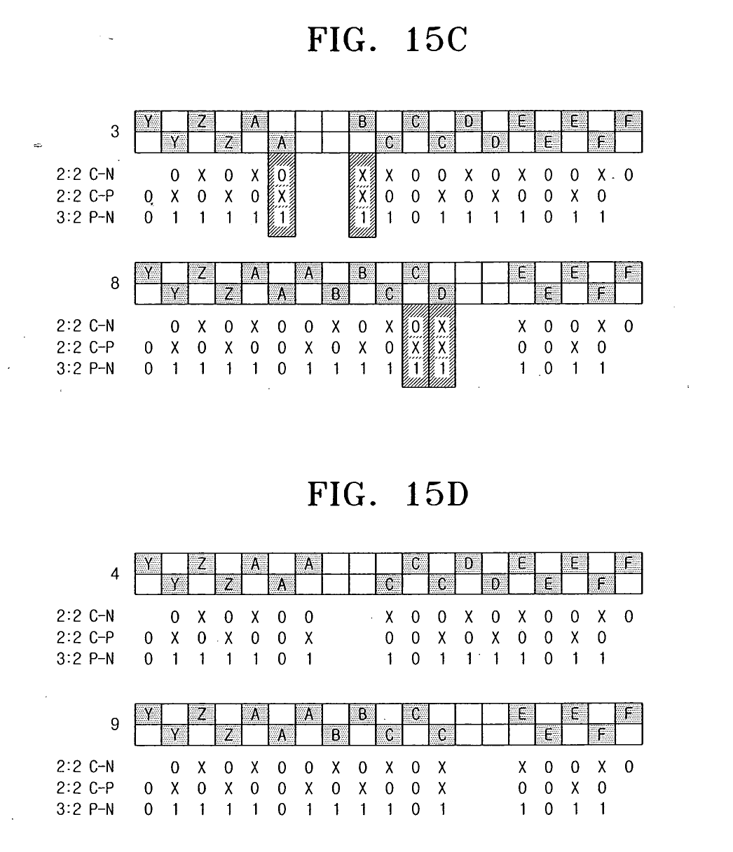

FIG. 14 is a flowchart showing a 2:2 pull-down image detection method performed by the 2:2 pull-down sub-detection unit of FIG. 3. Referring to FIG. 14, the absolute change amount calculation unit 373 of the 2:2 pull-down sub-detection unit 370 calculates the absolute change amount between the SADs calculated by the SAD calculation unit of the 2:2 pull-down main detection unit 350. That is, the absolute change amount calculation unit 373 calculates an absolute change amount between SADs calculated between the previous field (n−1) and the current field (n) and between the current field (n) and the next field (n+1). The absolute change amount storage unit 375 consecutively stores the absolute change amounts calculated by the absolute change amount calculation unit 373 (S1401). The second threshold value calculation unit 377 calculates a second threshold value by using the absolute change amounts consecutively stored in the absolute change amount storage unit 375 (S1403). In this case, the second minimum value detection unit 377a detects the minimum value of the absolute change amounts with respect to a specified section of the absolute change amounts stored in the absolute change amount storage unit 375. Also, the second maximum value detection unit 377b of the second threshold value calculation unit 377 detects the maximum value of the absolute change amounts with respect to the specified section of the absolute change amounts stored in the absolute change amount storage unit 375.

The second threshold value calculation unit 377 calculates the second threshold value based on the minimum value and the maximum value of the absolute change amounts detected by the second minimum value detection unit 377a and the second maximum value detection unit 377b, and the calculation of the second threshold value is performed by the following equation.
T4=c′×MIN′+d′×MAX′ [Equation 4]

Here, T4 denotes the second threshold value with respect to the field of the 2:2 pull-down image, c′ and d′ are certain values keeping c′+d′=1, MIN′ denotes the minimum value of the absolute change amounts in a specified section, and MAX′ denotes the maximum value of the absolute change amounts in the specified section.

The second pattern generation unit 379 generates patterns of the absolute change amounts stored in the absolute change amount storage unit 375 according to the second threshold value calculated by the second threshold value calculation unit 377 (step S1405). In this case, the second pattern generation unit 379 compares the absolute change amount with the second threshold value calculated by the second threshold value calculation unit 377, and generates ‘1’ if the absolute change amount is larger than the second threshold value. Otherwise, the second pattern generation unit 359 generates ‘0’. In the drawing, ‘+’ is marked instead of ‘1’, and ‘−’ instead of ‘0’.

The second pattern storage unit 381 consecutively stores the patterns of the absolute change amounts generated by the second pattern generation unit 379 (step S1407). The second pattern comparison unit 383 compares the pattern of the absolute change amount stored in the second pattern storage unit 381 with the predetermined basic pattern of the absolute change amount (step S1409). Here, the basic pattern of the absolute change amount means the basic pattern of the absolute change amount of the 2:2 pull-down image, and appears with two types. That is, the two types of the basic pattern of the absolute change amount are −+−+−+−+−+ and +−+−+−+−+−.

The sub-detection unit 370 detects the 2:2 pull-down image according to a result of comparison by the second pattern comparison unit 383 (step S1411). That is, if the pattern of the absolute change amount stored in the second pattern storage unit 381 is identical to the basic pattern of the absolute change amount, the 2:2 pull-down sub-detection unit 370 decides that the input image signal is the 2:2 pull-down image.

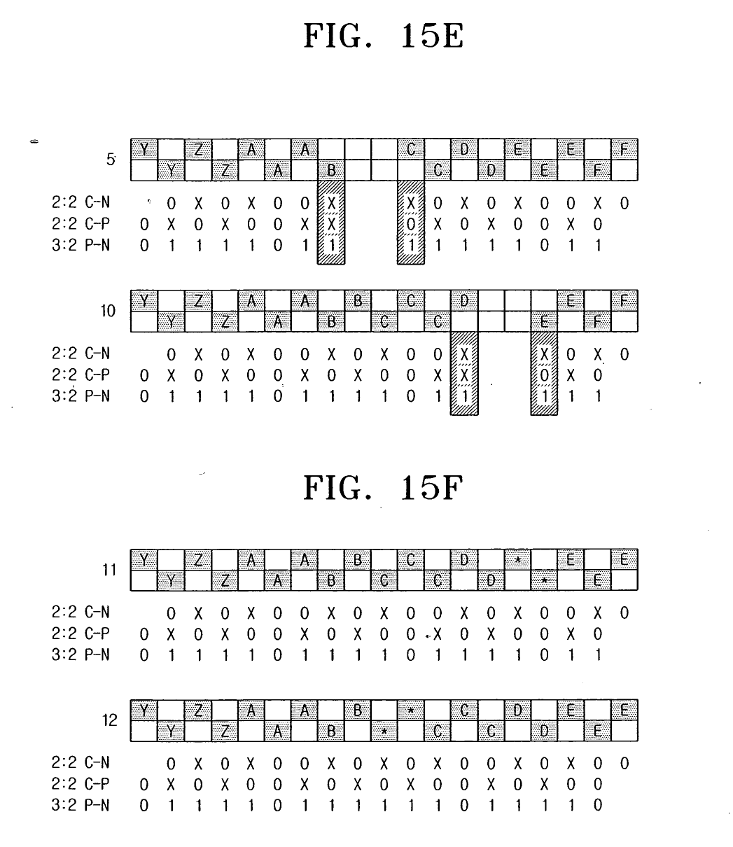

FIGS. 15A to 15F show examples of bad-edit occurring in the 3:2 pull-down image, to explain a bad-edit detection method of the bad-edit detection unit of FIG. 3.

If a normal image signal of 3:2 pull-down image, i.e., having no bad-edit, is input, the SAD in the 3:2 pull-down main detection unit 310 appears in the pattern of 0111101111. Meanwhile, the SAD in the 2:2 pull-down main detection unit 350 appears in the patterns of OXOXOXOXOX or XOXOXOXOXO. The pattern of SAD in the 3:2 pull-down main detection unit 310 and the pattern of SAD in the 2:2 pull-down main detection unit 350 are shown differently for the convenience of explanation.

If there occurs a bad-edit in which a field is omitted from the frame A, the pattern of SAD in the 3:2 pull-down main detection unit 310 becomes 1, while all of the patterns of the SADs in the 2:2 pull-down main detection unit 350, i.e., the pattern of SAD between the current field C and the next field N and the pattern of SAD between the current field C and the previous field P become all ‘x’. Also, with respect to the bottom field of the frame B, the pattern of SAD between the current field C and the next field N becomes ‘x’ and the pattern of SAD of the current field C and the previous field P becomes ‘o’, while the pattern of SAD between the previous field P and the next field N becomes 1. This patterns deviate from the basic pattern of the SAD, and this mans that there occurs a bad-edit in the 3:2 pull-down image. Several examples of the bad-edit occurrences are illustrated FIGS. 15B to 15F.

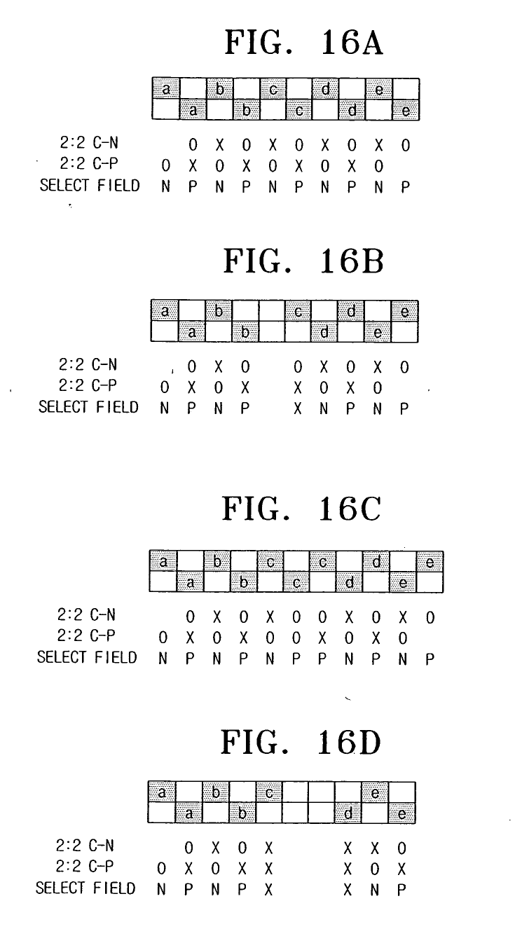

FIG. 16 shows examples of bad-edit occurring in the 2:2 pull-down image to explain a bad-edit detection method of the bad-edit detection unit of FIG. 3. In the normal 2:2 pull-down image signal without the bad-edit, the pattern of SAD between the current field C and the next field N and the pattern of SAD between the current field C and the previous field N appears in alternative manner (see FIG. 16A).

If there occurs a bad-edit in which the bottom field is omitted from the frame C, the pattern of SAD between the current field C and the next field N and the pattern of SAD between the current field C and the previous field P become all ‘x’. These patterns deviate from the basic pattern of the SAD of the 2:2 pull-down image, and this means that there occurs a bad-edit in the 2:2 pull-down image. Several examples of the bad-edit occurrences are illustrated in FIGS. 16B to 16D.

As described above, the bad-edit detection unit 395 detects whether there occurs a bad-edit in the 3:2 pull-down image or the 2:2 pull-down image by searching the patterns of SADs and the patterns of the absolute change amounts, which are detected by the 3:2 pull-down main detection unit 310, 3:2 pull-down sub-detection unit 330, 2:2 pull-down main detection unit 350 and the 2:2 pull-down sub-detection unit 370, respectively.

The still image determining unit 393 determines whether the input image signal is a still image based on the SAD and the absolute change amount. For example, if the presently calculated SAD and the SAD calculated before one field are very small in comparison to the previous SAD and the absolute change amount between the presently calculated SAD and the SAD calculated before one field is very small in comparison to the previous absolute change amount, the present input image is close to a still image. In this case, the pattern of the SAD and the pattern of the absolute change amount stored in the first pattern storage unit 321 and the second pattern storage unit 381 are as follows.
SAD_pattern[n−1]=0
SAD_pattern[n]=0
|ΔSAD|_pattern[n−1]=0

The decision unit 397 decides whether the input image signal is the 3:2 pull-down sequence or the 2:2 pull-down sequence by combining results of detecting the 3:2 pull-down image by the 3:2 pull-down main detection unit 310, the 3:2 pull-down sub-detection unit 330, the 2:2 pull-down main detection unit 350, and the 2:2 pull-down sub-detection unit 370, a result of determining whether the image signal is the still image by the still image determining unit 390, and a result of detecting whether there occurs a bad-edit by the bad-edit detection unit 395. Several examples of deciding the pull-down sequence by the decision unit 390 are shown in Table 1 below.

TABLE 1

| | | | Bad- | | | | | |
|---|---|---|---|---|---|---|---|---|
| Deci- | Previous | Still | edit | 3:2 | 3:2 | 2:2 | 2:2 | |
| sion | Flag | Flag | Flag | Main | Sub | Main | Sub | Count |
| 0 | 0 | X | X | 1 | 1 | X | X | count < ε |
| 1 | X | X | X | 1 | 1 | X | X | count = ε |
| 0 | 0 | X | X | 1 | 0 | 1 | 0 | X |
| 1 | 1 | X | X | 1 | 0 | 1 | 0 | X |
| 1 | 1 | 0 | X | 0 | 1 | 1 | 1 | X |
| 1 | 1 | 0 | 1 | 0 | 0 | 0 | 0 | X |

When it is detected that the image signal is the 3:2 pull-down image by the 3:2 pull-down main detection unit 310 and the 3:2 pull-down sub-detection unit 330, if the 3:2 pull-down image does not continue for a predetermined time, the decision unit 397 decides that the image signal is not the pull-down sequence irrespective of the previous flag, the still flag, and the bad-edit flag. On the contrary, if the 3:2 pull-down image continues for a predetermined time, the decision unit 397 decides the image signal to be the 3:2 pull-down sequence according to the result of detecting the 3:2 pull-down image by the 3:2 pull-down main detection unit 310 and the 3:2 pull-down sub-detection unit 330.

If the 3:2 pull-down main detection unit 310 and the 2:2 pull-down main-detection unit 350 detect the 3:2 pull-down image and the 2:2 pull-down image in a state that the previous flag is “0’, the decision unit 397 decides the image signal to be the pull-down sequence while maintaining the previous flag.

If the 3:2 pull-down main detection unit 310, the 3:2 pull-down sub-detection unit 330, the 2:2 pull-down main detection unit 350, and the 2:2 pull-down sub-detection unit 370 do not detect the pull-down image and the bad-edit detection unit 395 detects the bad-edit in a state that the previous flag is “1”, the decision unit 397 decides the image signal to be the pull-down sequence and maintains the previous flag. Here, the fact that the previous flag is “0” means that the 3:2 pull-down image is not decided with respect to the previous image signal.

Consequently, the image signal detecting apparatus according to the present invention can accurately detect the pull-down image by detecting the 3:2 pull-down image and the 2:2 pull-down image using the SAD and the absolute change amount. Also, the apparatus can prevent the displayed image from being unnatural by reducing the frequency of on/off operations of the pull-down image flag.

Also, as described above, since the image signal detecting apparatus detects the bad-edit by the bad-edit detection unit, and detects the image signal according to the detect result, compensation with respect to the image signal is achieved.

While the present invention has been described in detail, it should be understood that various changes, substitutions and alterations can be made hereto without departing from the spirit and scope of the invention as defined by the appended claims.

1. An image signal detecting apparatus, comprising:
a SAD calculation unit for calculating summed absolute differences (SADs) among a current field (n), a previous field (n−1), and a next field (n+1) with respect to consecutively input image signals with ‘n’ being n=1, 2, 3, . . . ;
a pull-down image detection unit for detecting a pull-down image based on the calculated SADs;
a still image determining unit for determining whether the input image signal is a still image or not based on the calculated SADs and absolute change amounts among the SADs;
a bad-edit detection unit for detecting a bad-edit in the detected pull-down image; and
a decision unit for deciding whether the input image signal is the pull-down image or not based on the result of detecting the pull-down image, the result of determining whether the input image signal is a still image by the still image judgment unit, and the result of detecting the occurrence of the bad-edit.

2. The image signal detecting apparatus of claim 2, wherein the pull-down image detection unit comprises:
a 3:2 pull-down image detection unit for detecting a 3:2 pull-down image; and
a 2:2 pull-down image detection unit for detecting a 2:2 pull-down image.

3. The image signal detecting apparatus of claim 2, wherein the 3:2 pull-down image detection unit comprises:
a main detection unit for detecting the 3:2 pull-down image based on a SAD between fields spaced from each other by 1 period; and
a sub detection unit for detecting the 3:2 pull-down image based on an absolute change amount with respect to the SAD between the 1 period-spaced fields.

4. The image signal detecting apparatus of claim 3, wherein the 3:2 pull-down image detection unit detects the 3:2 pull-down image by generating patterns of the SADs between the 1 period-spaced fields and patterns of the absolute change amounts, and comparing the patterns of the SADs and the patterns of the absolute change amounts with a basic pattern of the 3:2 pull-down image.

5. The image signal detecting apparatus of claim 2, wherein the 2:2 pull-down image detection unit comprises:
a main detection unit for detecting the 2:2 pull-down image based on a SAD between consecutive fields; and
a sub-detection unit for detecting the 2:2 pull-down image based on an absolute change amount with respect to the SAD between the consecutive fields.

6. The image signal detecting apparatus of claim 5, wherein the 2:2 pull-down image detection unit detects the 2:2 pull-down image by generating patterns of the SADs between the consecutive fields and patterns of the absolute change amounts, and comparing the patterns of the SADs and the patterns of the absolute change amounts with a basic pattern of the 2:2 pull-down image.

7. An image signal detecting method comprising:
a SAD calculating step of calculating SADs among a current field (n), a previous field (n−1), and a next field (n+1) with respect to consecutively input image signals with ‘n’ being n=1, 2, 3, . . . ;
a pull-down image detection step of detecting a pull-down image based on the calculated SADs;
a still image judgment step of judging whether the input image signal is a still image based on the calculated SADs and absolute change amounts among the SADs;
a bad-edit detection step of detecting a bad-edit in the detected pull-down image; and
a pull-down image decision step of deciding whether the input image signal is the pull-down image or not based on the result of detecting the pull-down image, the result of judging whether the input image signal is a still image by the still image judgment step, and the result of detecting the occurrence of the bad-edit.

8. The image signal detecting method of claim 7, wherein the pull-down image detection step comprises:
a 3:2 pull-down image detection step of detecting a 3:2 pull-down image; and
a 2:2 pull-down image detection step of detecting a 2:2 pull-down image.

9. The image signal detecting method of claim 8, wherein the 3:2 pull-down image detection step comprises:
a main detection step of detecting the 3:2 pull-down image based on a SAD between fields spaced from each other by 1 period; and
a sub-detection step of detecting the 3:2 pull-down image based on an absolute change amount with respect to the SAD between the 1 period-spaced fields.

10. The image signal detecting method of claim 8, wherein the 2:2 pull-down image detection step comprises:
a main detection step of detecting the 2:2 pull-down image based on a SAD between consecutive fields; and
a sub-detection step of detecting the 2:2 pull-down image based on an absolute change amount with respect to the SAD between the consecutive fields.

11. The image signal detecting method of 9, wherein the main detection step comprises:
consecutively storing the SADs between the 1 period-spaced fields;
calculating a first threshold value using the consecutively stored SADs;
generating patterns of the SADs according to the calculated first threshold value;
consecutively storing the patterns of the SADs; and
comparing the stored patterns of the SADs with a predetermined basic pattern of the SAD, and
the main detection step detects the 3:2 pull-down image according to the result of the comparison by the SAD pattern comparison step.

12. The image signal detecting method of claim 9, wherein the sub-detection step comprises:
consecutively storing absolute change amounts with respect to the SADs between the 1 period-spaced fields;
calculating a second threshold value using the consecutively stored absolute change amounts;
generating patterns of the absolute change amounts according to the calculated second threshold value;
consecutively storing the patterns of the absolute change amounts; and
comparing the patterns of the stored absolute change amounts with a predetermined basic pattern of the absolute change amounts,
wherein the sub detection step detects the 3:2 pull-down image according to the result of the comparison by the absolute change amount pattern comparison step.

13. The image signal detecting method of 10, wherein the main detection step comprises:
consecutively storing the SADs between consecutive fields;
calculating a first threshold value using the consecutively stored SADs;
generating patterns of the SADs according to the calculated first threshold value;
consecutively storing the patterns of the SADs; and
comparing the stored patterns of the SADs with a predetermined basic pattern of the SAD,
wherein the main detection step detects the 2:2 pull-down image according to the result of the comparison by the SAD pattern comparison step.

14. The image signal detecting method of claim 10, wherein the sub-dectection step comprises:
consecutively storing absolute change amounts with respect to the SADs between the consecutive fields;
calculating a second threshold value using the consecutively-stored absolute change amounts;
generating patterns of the absolute change amount according to the calculated second threshold value;
consecutively storing the patterns of the absolute change amounts; and
comparing the patterns of the stored absolute change amounts with a predetermined basic pattern of the absolute change amount,
wherein the sub-detection step detects the 2:2 pull-down image according to the result of the comparison by the absolute change amount pattern comparison step.
